(19) United States
(12) Patent Application Publication
(10) Pub. No.: US 2011/0138026 A1
(43) Pub. Date: Jun. 9, 2011

(54) OPERATING METHOD OF NETWORK NODE OF NETWORK WITH TREE STRUCTURE BASED ON DISTRIBUTED ADDRESS ASSIGNMENT, NETWORK FORMING METHOD AND SYSTEM INCLUDING NETWORK NODE

(75) Inventors: Hoon Jeong, Deajeon (KR); Jongjun Park, Deajeon (KR); Seong-soon Joo, Deajeon (KR); Jong-Suk Chae, Deajeon (KR)

(73) Assignee: ELECTRONICS AND TELECOMMUNICATIONS RESEARCH INSTITUTE, Daejeon (KR)

(21) Appl. No.: 12/821,424

(22) Filed: Jun. 23, 2010

(30) Foreign Application Priority Data
Dec. 7, 2009 (KR) 10-2009-0120601

(51) Int. Cl. G06F 15/177; G06F 15/173

(52) U.S. Cl. 709/222; 709/238

(57) ABSTRACT

Provided is a method for operating a network node of a tree-structured network based on distributed address assignment. Addresses are assigned. It is determined whether a routing depth of the network node corresponds to a reduced node depth. It is determined whether an authority for generating an inferior node exists using the assigned address when the routing depth of the network node corresponds to the reduced node depth. The inferior node is generated using a result of the determination.

### CROSS-REFERENCE TO RELATED APPLICATIONS

This U.S. non-provisional patent application claims priority under 35 U.S.C. §119 of Korean Patent Application No. 10-2009-0120601, filed on Dec. 7, 2009, the entire contents of which are hereby incorporated by reference.

### BACKGROUND OF THE INVENTION

The present invention disclosed herein relates to a network, and more particularly, to an operating method of a network node of a network with a tree structure based on distributed address assignment, a network forming method, and a system including the network node.

With development of network technologies, studies are being actively conducted on Ubiquitous Sensor Network (USN). USN realizes real-time collection and building of information on objects and environments.

In USN, the addresses of the network nodes are assigned based on Distributed Address Assignment (DAA) or Centralized Address Assignment (CAA). DAA represents an address assignment method in which an address assignment function of a network node is distributed over a network. For example, a plurality of network nodes have the address assignment authority. CAA represents an address assignment method in which a coordinator node or a sink node of a network has the address assignment authority.

USN has a mesh topology or a tree topology. The mesh topology has a configuration in which one network node can communicate with a plurality of network node. The tree topology has a configuration in which one network node can communicate with a parent node and a child node. That is, when first and second nodes communicate with each other in the mesh topology, the first and second nodes can communicate with each other directly. On the other hand, in the tree topology, when the branches of the first and second network nodes are different from each other, the communication is performed via the uppermost node (for example, a coordinator node or a sink node).

### SUMMARY OF THE INVENTION

The present invention provides improved scalability to a tree-structured network based on distributed address assignment.

The present invention also reduces address waste in a tree-structured network based on distributed address assignment.

Embodiments of the present invention provide methods for operating a network node of a tree-structured network based on distributed address assignment including: assigning addresses; determining whether a routing depth of the network node corresponds to a reduced node depth; determining whether an authority for generating an inferior node exists using the assigned address when the routing depth of the network node corresponds to the reduced node depth; and generating the inferior node using a result of the determination.

In some embodiments, the generating of the inferior node may include generating the inferior node when the determination result shows the existence of the authority.

In other embodiments, the generating of the inferior node may include inhibiting generation of the inferior node when the determination result shows absence of the authority.

In still other embodiments, the reduced node depth may be smaller than the routing depth of the network.

In other embodiments of the present invention, methods for forming a tree-structured network based on distributed address assignment includes: setting a reduced node depth; and forming a network using the reduced node depth, wherein a portion of inferior nodes of a node having a routing depth corresponding to the reduced node depth is not allowed to have an inferior node.

In some embodiments, the portion of the inferior nodes may include routing nodes.

In other embodiments, the reduced node depth may be smaller than the routing depth of the network.

In still other embodiments, respective network nodes of the network may determine whether to have an inferior node based on an assigned address.

In other embodiments of the present invention, systems include: a coordinator node; and a plurality of sensor nodes connected to the coordinator node in a tree structure, wherein the coordinator and the plurality of sensor nodes are assigned with addresses based on distributed address assignment, and a portion of the sensor nodes having a routing depth corresponding to a reduced node depth is not allowed to have an inferior node.

In some embodiments, the portion of the sensor nodes may include routing nodes.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a topology of a sensor network according to a first embodiment;

FIG. 2 is a diagram illustrating a sensor network (10) configured with sensor nodes according to the topology of FIG. 1 according to an embodiment;

FIG. 3 is a diagram illustrating an example of registering all sensor node of FIG. 2 in the sensor network;

FIG. 4 is a diagram illustrating a topology of a sensor network according to a second embodiment;

FIG. 5 is a block diagram illustrating a sensor network configured according to the topology of FIG. 4 according to an embodiment;

FIG. 6 is a diagram illustrating a topology of a sensor network according to a third embodiment;

FIG. 7 is a block diagram illustrating a sensor network configured according to the topology of FIG. 5 according to an embodiment;

FIG. 8 is a flowchart illustrating an operation of a network node in the sensor networks of FIGS. 5 and 7;

FIG. 9 is a flowchart illustrating an address operation of FIG. 8;

FIG. 10 is a flowchart illustrating a method for an authorized node to calculate addresses to be assigned to inferior node of a sub cluster;

FIG. 11 is a diagram illustrating a sensor system including a sensor network of FIG. 5 or 7 according to a first embodiment; and

FIG. 12 is a diagram illustrating a sensor system including a sensor network of FIG. 5 or 7 according to a second embodiment.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, embodiments according to the technical spirit of the present invention will be described in detail with reference to a sensor network. However, the technical spirit should not be construed as limited only to application to the sensor network. A sensor network according to an embodiment will be assumed to be a network with a tree structure based on Distributed Address Assignment (DAA). For example, a sensor network according to an embodiment will be assumed to be an IEEE 802.15.4 ZigBee network. However, the technical spirit of the present invention should not be construed as limited to the network with the tree structure based on DAA or the IEEE 802.15.4 ZigBee network.

Hereinafter, a network according to an embodiment will be referred to as a term ‘network’ or ‘sensor network’. Also, network nodes according to an embodiment will be referred to as a term ‘sensor node’ or ‘network node’. A parent node or a superior node indicates one of network nodes, which is used as the opposite concept to that of a child node or an inferior node.

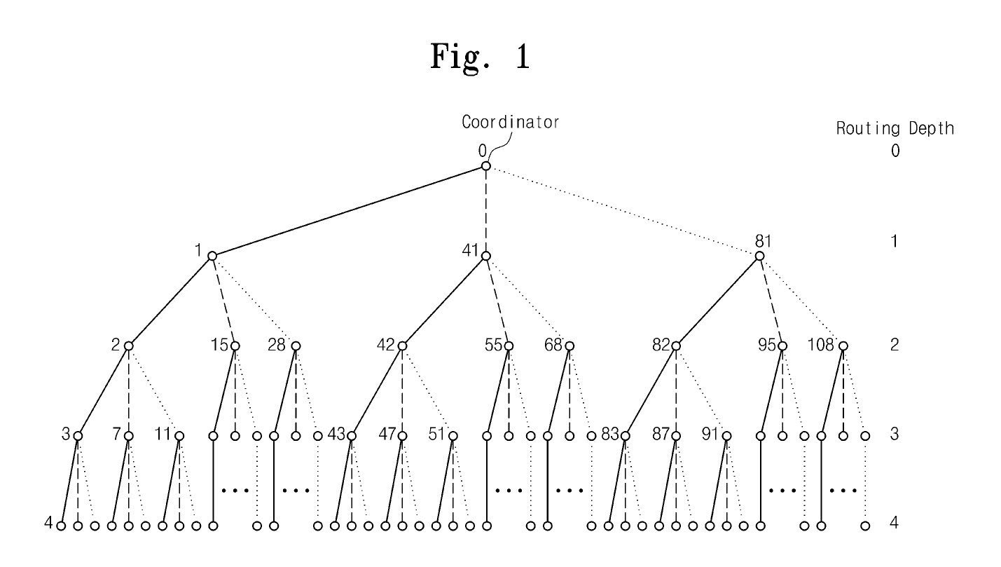

FIG. 1 is a diagram illustrating a topology of a sensor network according to an embodiment. Referring to FIG. 1, the sensor network may include a topology of a tree structure.

A network (for example, ZigBee network) with a tree structure based on the distributed address assignment may be defined using three parameters. The three parameters defining a network are described in Table 1 below.

TABLE 1

| Parameter | Meaning |
|---|---|
| Lm | Max Depth |
| Cm | Max Child |
| Rm | Max router |

A routing depth of the uppermost node (for example, a coordinator node or a sink node) is 0 in a tree structure. The network nodes having a routing depth of 1 are connected to the uppermost node through one hop. That is, the routing depth of inferior nodes of the uppermost node is 1. The network nodes having a routing depth of 2 are connected to the uppermost node through two hops. That is, the routing depth of inferior nodes of the uppermost node is 2. Thus, it can be understood that the routing depth represents how many hops are required for a network node to be connected to the uppermost node or what order in the inferior nodes the network node is from the uppermost node.

The max depth Lm represents a max routing depth that a network can have. For example, if the max depth Lm is 2, the network may have network nodes having a routing depth of 0 to 2. That is, the uppermost node having a routing depth of 0, inferior nodes having a routing depth of 1, and inferior nodes having a routing depth of 2 inferior to the inferior nodes may be registered in a network.

The max child Cm represents the maximum number of inferior nodes that a network node can have. That is, if the max child Cm is 3, a network node can have three inferior nodes.

The max router Rm represents the number of routing nodes among inferior nodes of a network node. Nodes except routing nodes from inferior nodes of a network are end devicees. For example, if the max child Cm is 3, and the max router Rm is 2, then the network node may have three child nodes, two of the three child nodes are routing nodes, and the other node is an end device.

For example, the routing node is a Full Function Device (FFD), and the end device is a Reduced Function Device (RFD). The routing node may be configured to perform an operation of a typical sensor node such as sensing, and additionally to perform a routing function between network nodes. That is, the routing node may deliver a message from a parent node to a child node, and a message from the child node to the parent node.

The end device may not have a routing function, and may not have a communication function with another end device. That is, the end device may not be used as a parent node of another network node, and may not be used as a child node of another end device. The end device is registered as a child node of a routing node, and does not have a child node.

A network is generated based on the max depth Lm, the max child Cm, and the max router Rm. For example, a network having a max depth Lm of 4, a max child Cm of 3, and a max router Rm of 3 is shown in FIG. 1.

The uppermost node CO is called a coordinator node or a sink node. The coordinator node may be connected to an external network (for example, Broadband Convergence Network (BcN) through a gateway. The routing depth of the coordinator CO is 0. The coordinator CO may have a number of child nodes corresponding to the max child Cm. Since the max child CM is equal to the max router Rm, all the child nodes of the coordinator node CO are router nodes.

The child nodes of the coordinator node CO have three child nodes, respectively. All of the child nodes are router nodes. Similarly, the network nodes are extended based on the max child Cm and the max router until a network node having a routing depth of 4 is connected.

As shown in FIG. 1, the parent nodes have the child nodes that are connected using a solid line, a broken line, and a dotted line. A child node connected using the solid line is defined as a first child node. A child node connected using the broken line is defined as a second child node. A child node connected using the dotted line is defined as a third child node. The forms of the line connecting between the parent nodes and the child nodes are divided for convenience of explanation, and should not be construed as representing different communication means or methods.

For example, addresses of child nodes of a specific network node are sequentially assigned in order of first to third child nodes. Addresses are assigned to inferior nodes of the first child node of the specific network earlier than the second and third child nodes of the specific node. As shown in FIG. 1, addresses are assigned to the network nodes.

As described above, if the max depth Lm, and the max child Cm, and the max router Rm of the network are defined, a network having the topology and the addresses as described in FIG. 1 is generated. That is, the addresses assigned to the network nodes are not determined by the registration order on the network or by the coordinator, but are determined by the locations of the registered network nodes on the topology.

For example, it is assumed that a non-registered network node is connected to a network node having a routing depth of 1 and an address of 1. As shown in FIG. 1, nodes connected to the network node having the address of 1 are determined to be assigned with the addresses 2, 15 and 28. Accordingly, when the non-registered node is connected to the network node of the address 1, the network node having the address 1 may assign one of the addresses 2, 15 and 28 to the non-registered node.

If the fist child node is connected, the network node having the address 1 assigns the address 2 to the first child node. If the second child node is connected, the network node having the address 1 assigns the address 15 to the second child node. If the third child node is connected, the network node having the address 1 assigns the address 28 to the third child node. Even before all the inferior nodes of the first child node having the address 2 are registered, it is possible for the network node having the address 1 to assign the address 15 to the second child node.

As described above, the address of the child node is assigned by the parent node. That is, the addresses are assigned to the network nodes based on the distributed address assignment.

The function Cskip(d) can be expressed as Equation (1) below.

$$Cskip ( d ) = 1 + Cm \cdot ( Lm - d - 1 ) , if Rm = 1 \\ Cskip ( d ) = \frac{1 + Cm - Rm - Cm \cdot {Rm}^{Lm - d - 1}}{1 - Rm} , if Rm \neq 1 \qquad ( 1 )$$

It can be understood that the function Cskip(d) represents the sum of the number of network nodes (more particularly, routing nodes) corresponding to a routing depth of ‘d+1’ and the inferior nodes thereof. That is, the function Cskip(0) represents the sum of the number of the network node having a routing depth of 1 and the inferior nodes thereof. In FIG. 1, the max depth Lm is 4, the max child Cm is 3, and the max router is 3. Accordingly, Cskip(0) is 40. As shown in FIG. 1, the addresses of the network node having a routing depth of 1 and an address of 1 and the inferior nodes thereof correspond to the addresses 1 to 40. That is, the sum of the number of the network node having a routing depth 1 and an address of 1 and the inferior nodes is 40.

Similarly, the addresses of the network node having a routing depth of 1 and an address of 41 and the inferior nodes thereof correspond to the addresses 41 to 80. That is, the sum of the number of the network node having a routing depth of 1 and an address of 41 and the inferior nodes thereof is 40.

The addresses of the network node having a routing depth of 1 and an address of 81 and the inferior nodes thereof correspond to the addresses 81 to 120. That is, the sum of the number of the network node having a routing depth of 1 and an address of 81 and the inferior nodes thereof is 40.

Since the topology and the address are determined based on the max depth Lm, the max child Cm, and the max router Rm, the maximum number of the addresses of the network can be calculated based on the max depth Lm, the max child Cm, and the max router Rm. The maximum number of the addresses of the network can be expressed as Equation (2) below.

MaxAddress=Cskip(0)×Rm+Cm−Rm+1 (2)

Cskip(0) represents the sum of the number of the network node having a routing depth of 1 and the child nodes thereof. Accordingly, the multiply of Cskip(0) and the max router Rm represents the sum of the number of the router nodes of the child nodes of the coordinator node and the child nodes thereof. If the number (Cm−Rm) of the end devices among the child nodes of the coordinator node is added to the above multiply, and the number of the coordinator node, 1 is added, the maximum number of the addresses of the network (or the maximum number of the network nodes) is calculated. Cskip(0) is 40, the max router Rm is 3, and the max child Cm is 3. Accordingly, the maximum number of the addresses is 122. Referring to FIG. 1, the network nodes are described as having the addresses 0 to 121. That is, 122 network nodes constitute a network in FIG. 1.

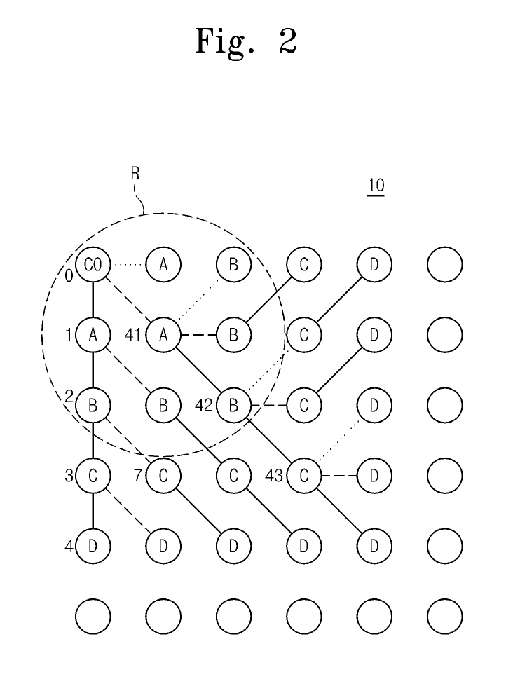

FIG. 2 is a diagram illustrating a sensor network 10 configured with sensor nodes according to the topology of FIG. 1 according to an embodiment. Referring to FIG. 2, the sensor nodes are arranged in a matrix type. The reference numerals described at the sides of the sensor nodes represents addresses. The reference symbol ‘CO” in the sensor node represents a coordinator node. The reference symbol ‘A’ represents network nodes having a routing depth of 1. The reference symbol ‘B’ represents network nodes having a routing depth of 2. The reference symbol ‘C’ represents network nodes having a routing depth of 3. The reference symbol ‘D’ represents network nodes having a routing depth of 4. The reference symbol ‘E’ represents network nodes having a routing depth of 5.

For example, the sensor nodes are assumed to perform wireless communication using a wireless communication means. According to the performance of the communication means, the sensor nodes have a communicable range. For example, the greater the amount of power is distributed to the communication means, and the more the cost increases, the more the communicable range of the sensor nodes increases.

The sensor network 10 includes sensor nodes consuming low cost and low energy. The communicable range of one sensor node can not cover the entire sensor network 10. Accordingly, sensor nodes out of the communicable range of the coordinator node CO may communicate with the coordinator node CO through other sensor nodes, i.e., multihop.

For example, a communicable range R of the second child node A (address 41) of the coordinator node CO is shown in FIG. 2. Network nodes of the sensor networks 10 are assumed to have the same communicable range R, respectively.

As described with reference to FIG. 1, if the max depth Lm, the max child Cm, and the max router Rm are set, the topology and addresses of the network are determined. The respective sensor nodes have the communicable range R. Accordingly, all the network nodes having the addresses 1 to 121 in FIG. 1 are not registered in the network.

As described with reference to FIG. 1, the sensor network 10 having a max depth Lm of 4, a max child Cm of 3, and a max router Rm of 3 is described in FIG. 2.

As shown in FIG. 1, the address 6 is assigned to the third child node of the network node C having the address 3. However, in FIG. 2, the network node C having the address 3 does not have the third child node. That is, the address 6 is wasted in the sensor network 10. The network node C having the address 7 does not have the second and third child nodes. Accordingly, the addresses 9 and 10 are wasted. Among the sensor nodes of the sensor network 10, only the coordinator node CO having the address 0, the network node B having a routing depth of 2 and an address of 42, and the network node C having a routing depth of 3 and an address of 43 have all the first to third child nodes. Accordingly, at least one child node is not registered on the other network nodes, respectively. That is, the addresses 6, 9 to 14, 18 to 40, 49 and 50, 53 and 54, 57 to 67, 69 to 80, and 82 to 121 are wasted in the sensor network 10.

That is, the maximum number of the addresses of the sensor network 10 having a max depth Lm of 4, a max child Cm of 3, and a max router Rm of 3 is 122, but the number of the registered network nodes is 25. That is, 97 addresses are wasted in the sensor network 10.

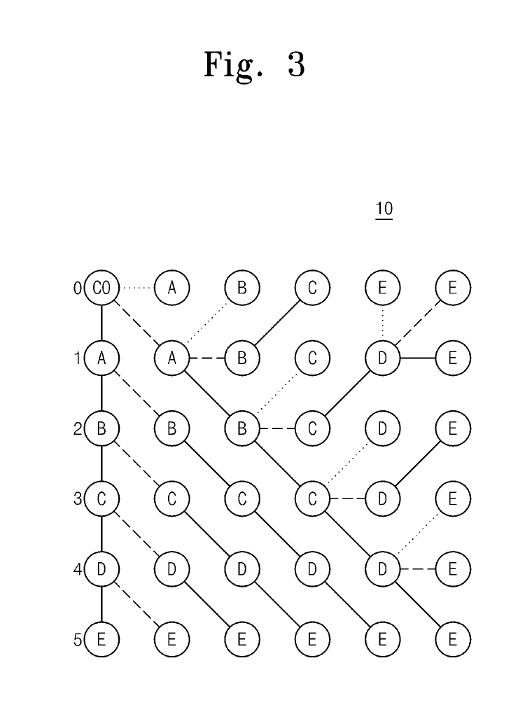

To register all the sensor nodes in FIG. 2 in the sensor network, the network nodes D having a routing depth of 4 have to be configured to have child nodes as well. That is, the max depth Lm of the sensor network 10 has to be increased. A sensor network 20 on which all sensor nodes are registered due to an increase of the max depth Lm of the sensor network 10 is shown in FIG. 3. Referring to FIGS. 2 and 3, the sensor network 20 may have child nodes E of a routing depth of 5.

To resister child nodes of a routing depth of 5, the max depth Lm of the sensor network 20 has to be equal to or greater than 5. The maximum number of the addresses of a sensor network having a max depth Lm of 5 may be calculated by referring to Equation (2) above. The maximum number of the addresses of the sensor network having a max depth Lm of 5 is 364. That is, the number of registrable network nodes is 364. On the other hand, the number of the network nodes registered on the sensor network 20 is 36. That is, 348 addresses are wasted in the sensor network 20.

For example, a ZigBee network uses a 16-bit address. The number of assignable addresses by 16-bit address is 2̂16=65,535. The maximum number of the addresses of the sensor network 10 is defined by Equation (2) above. It is assumed that the max child Cm and the max router Rm are fixed to 3 and 3, respectively, and the max depth Lm increases. In this case, the relation between the max depth Lm and the max address is described in Table 2.

TABLE 2

| Max Depth (Lm) | Max Address |
|---|---|
| 4 | 121 |
| 5 | 364 |
| 6 | 1093 |
| . . . | . . . |
| 9 | 29524 |
| 10 | 88573 |
| 11 | 265720 |

The maximum number of addresses is a function of Cskip (0). Cskip(0) is a function depending on the square of the max depth Lm with respect to the max router Rm. That is, as the max depth Lm increases, the maximum number of the addresses increases geometrically. As described in Table 2, if the max depth Lm reaches 10, the maximum number of the addresses of the sensor network is 88,573. This is greater than the number (65,535) of assignable addresses with 16-bit address. Accordingly, in a network in which the 16-bit address is used and the max child Cm and the max router Rm are set to 3 and 3, respectively, the max depth Lm is limited to a value smaller than 10.

In brief, the topology described with reference to FIGS. 1 and 2 may incur waste of address, and the max depth Lm may be limited. Also, as the max depth Lm increases, the number of wasted addresses may increase progressively.

To solve the above limitation, the sensor network according to the embodiment may define a reduced node depth TRm. If the reduced node depth TRm is defined, only a part (for example, only one) of child nodes of the network node, the routing depth of which corresponds to the reduced node depth TRm, may be allowed to have inferior nodes. That is, a portion of the inferior nodes of the network node, the routing depth of which corresponds to the reduced node depth TRm, may not be allowed to have inferior nodes.

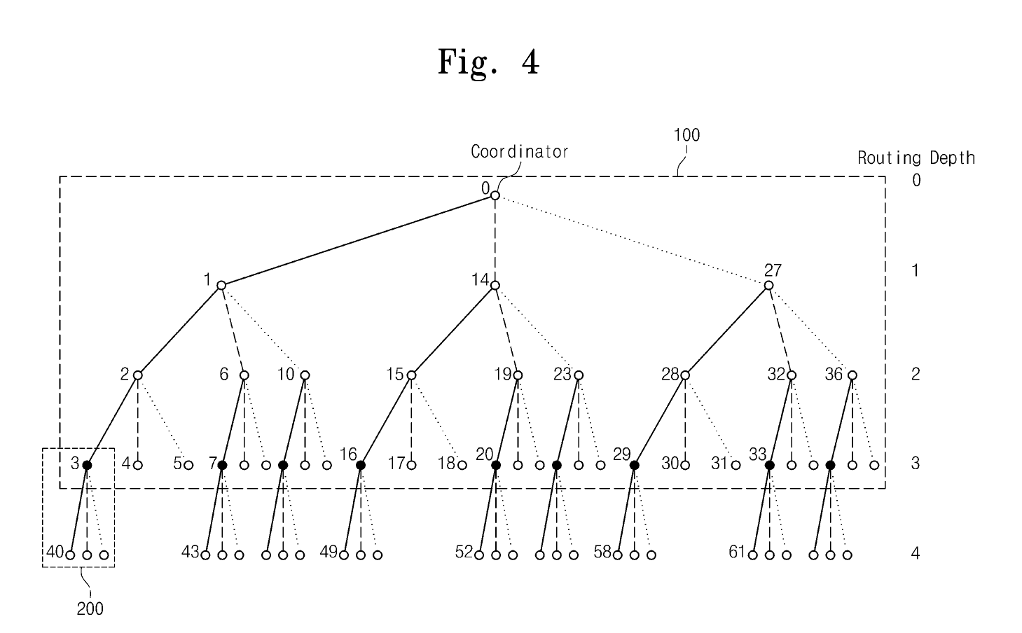

FIG. 4 is a diagram illustrating a topology of a sensor network according to a second embodiment. Referring to FIG. 4, only the first child nodes of the network nodes corresponding to the routing depth of 2 have inferior nodes. That is, the reduced node depth TRm is set to 2 in FIG. 4.

Hereinafter, among inferior nodes of network nodes having a routing depth corresponding to the reduced node depth TRm, the network nodes authorized to have inferior nodes are called authorized nodes. A network part formed by inferior nodes of the network nodes corresponding to the reduced node depth TRm from the coordinator node CO is called a main cluster 100. A network part generated up to the max depth Lm from one authorized node is called a sub cluster 200. That is, the sensor network may include one main cluster 100 and a plurality of sub clusters 200.

For example, parameters constituting the topology of FIG. 4 are described in Table 3 below.

TABLE 3

| Parameter | Value |
|---|---|
| Max Depth (Lm) | 4 |
| Max Child (Cm) | 3 |
| Max Router (Rm) | 3 |
| Reduced Node Depth (TRM) | 3 |
| Authorized Node | First Child Node |

In FIG. 4, the authorized nodes are represented by black.

The addresses of the network nodes are sequentially assigned to the main cluster 100 and the sub clusters 200. The routing depth of the main cluster 100 reaches the reduced node depth TRm. Based on the reduced node depth TRm, the max child Cm, and the max router Rm, the main cluster 100 may be assigned with addresses. The address assignment method may be identical to the method described with reference to FIG. 1.

Then, the sub clusters 200 may be assigned with addresses. In the sub cluster 200, as described with reference to FIG. 1, addresses are assigned in order from the first child node and the inferior nodes thereof to the third child node and the inferior nodes thereof. Also, addresses are assigned in order from a sub cluster connected to an authorized node having a low address to a sub cluster connected to an authorized node having a high address.

Functions Cskip1(d) and Cskip2(d) are expressed as Equation (3) below.

$$Cslip 1 ( d ) = 1 + Cm \cdot ( TRm - d ) , if Rm = 1 \\ Cskip 1 ( d ) = \frac{1 + Cm - Rm - Cm \cdot {Rm}^{TRm - d}}{1 - Rm} , if Rm \neq 1 \\ Cskip 2 ( d ) = 1 + Cm \cdot ( Lm - TRm - d - 2 ) , if Rm = 1 \\ Cskip 2 ( d ) = \frac{1 + Cm - Rm - Cm \cdot {Rm}^{Lm - TRm - d - 2}}{1 - Rm} , if Rm \neq 1 \qquad ( 3 )$$

Compared to Equation (1), Lm of Cskip(d) is replaced with ‘TRm+1’ in Cskip1(d). That is, Cskip1(d) can be understood as an application of Cskip(d) to the main cluster 100. Lm of Cskip(d) is replaced with ‘Lm−(TRm+1)’ in Cskip2(d). That is, Cskip2(d) can be understood as an application of Cskip(d) to the sub cluster 200.

Based on Equation (3), the maximum number of addresses can be calculated in the topology of FIG. 4.

The maximum number of addresses is defined as Equation (4) in the topology of FIG. 4

MaxAddress=Cskip1(0)+Cm−Rm+1+Rm^{TRm}·n·(Cskip2(0)·Rm+Cm−Rm) (4)

The first line of Equation (4) represents the maximum number of addresses of the main cluster.

Except that Cskip(0) is replaced with Cskip1(0), the first line of Equation (4) is identical to Equation (2).

The second line of Equation (4) represents the maximum number of addresses of the sub cluster. Compared to Equation (2), Cskip(0) is replaced with Cskip2(0). The sub coordinator node of the sub cluster may also be a node of the main cluster. That is, the number of nodes is duplicated.

Accordingly, ‘+1’ of Equation (2) is removed from Equation (4). Rm̂TRm represents the number of the network nodes corresponding to the reduced node depth TRm. n represents the number of the authorized nodes among the child nodes of the network node of the reduced node depth TRm. That is, (Rm̂TRm)n represents the total number of the authorized nodes.

In the topology described in FIG. 4, the max depth Lm is 4, the max child Cm is 3, the max router Rm is 3, the reduced node depth TRm is 2, and the number of the authorized nodes is 1. In this case, Cskip1(0) is 13, and Cskip2(0) is 1.

Based on Cskip1(0) and Cskip2(0), the maximum number of addresses may be calculated. The maximum number of addresses is 67. Referring to FIG. 4, the network nodes have addresses of 0 to 66. That is, the maximum number of addresses is 67 in the topology of FIG. 4.

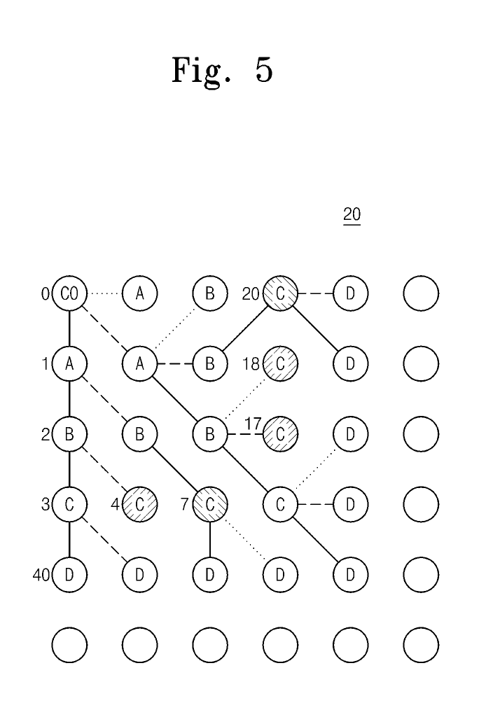

FIG. 5 is a block diagram illustrating a sensor network configured according to the topology of FIG. 4 according to an embodiment. As shown in FIG. 2, 25 network nodes are registered in the sensor network 10. When the topology is changed from the sensor network 10 of FIG. 2 to the sensor network 20 of FIG. 5, the network nodes C of FIG. 4 having the addresses 4, 17 and 18 may not be allowed to have child nodes. When the topology is changed from the sensor network 10 of FIG. 2 to the sensor network 20 of FIG. 5, the second child node may be added to the network node of FIG. 4 having the address 7, and the second child node may be added to the network node of FIG. 4 having the address 20.

In FIG. 2, the maximum number of addresses of the sensor network 10 is 122. Then, 25 network nodes are registered in the sensor network 10. That is, 97 addresses are wasted. In FIG. 5, the maximum number of addresses of the sensor network 20 is 67. Then, 25 network nodes are registered in the sensor network 20. That is, 42 addresses are wasted. Accordingly, the address usage efficiency of the sensor network 20 of FIG. 5 is higher than that of the sensor network 10 of FIG. 2.

The maximum number of addresses according to the max depth Lm of the sensor network 10 of FIG. 2 has been described in Table 3. The maximum number of addresses according to the max depth Lm of the sensor network 20 of FIG. 5 is described in Table 4 below.

TABLE 4

| Max Depth (Lm) | MaxAddress |
|---|---|
| 4 | 67 |
| 5 | 148 |
| 6 | 391 |
| . . . | . . . |
| 10 | 29551 |
| 11 | 88600 |
| 12 | 265747 |

That is, when the sensor network 20 of FIG. 5 uses a 16-bit address, the max depth Lm may be extended to 10. On the other hand, the max depth Lm of the sensor network 10 of FIG. 2 may be extended to 9. Accordingly, the scalability of the sensor network 20 of FIG. 5 is higher than that of the sensor network 10 of FIG. 2.

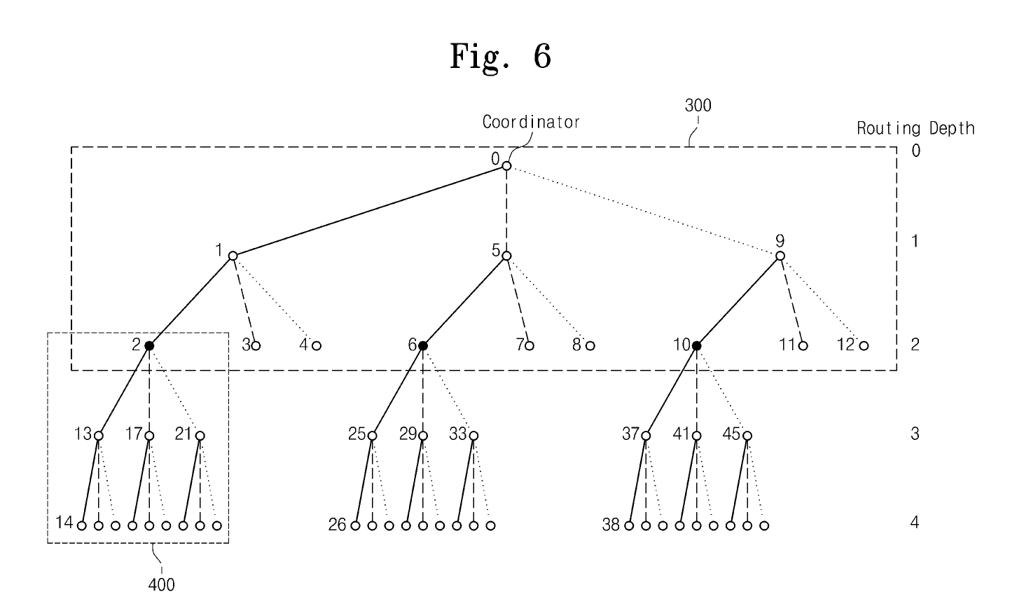

FIG. 6 is a diagram illustrating a topology of a sensor network according to a third embodiment. In FIG. 6, the max depth Lm is 4, the max child Cm is 3, The max router Rm is 3, the reduced node depth TRm is 1, and the authorized node is one, the first child node. The network nodes having a router depth of 0 to 2 may constitute a main cluster 300, and the network nodes having a router depth of 3 and 4 may constitute a sub cluster 400.

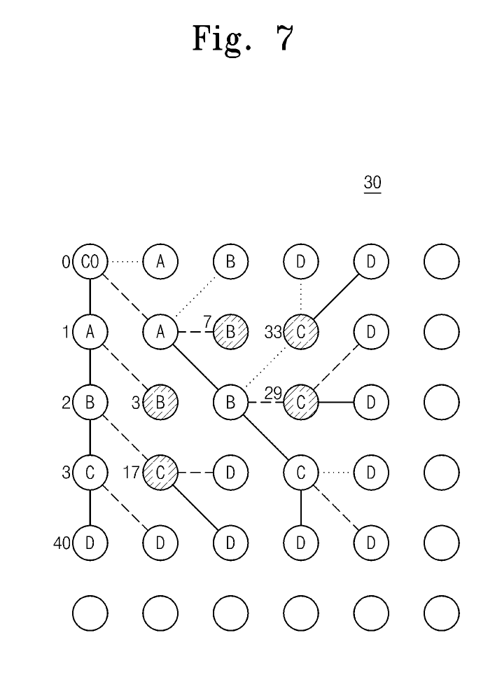

FIG. 7 is a block diagram illustrating a sensor network 30 configured according to the topology of FIG. 5 according to an embodiment. As shown in FIG. 2, 25 network nodes are registered in the sensor network 10. When the topology is changed from the sensor network 10 of FIG. 2 to the sensor network 30 of FIG. 7, the network nodes C of FIG. 7 having the addresses 3, and 7 may not be allowed to have child nodes. When the topology is changed from the sensor network 10 of FIG. 2 to the sensor network 30 of FIG. 7, the second child node may be added to the network node C of FIG. 7 having the address 17, the second child node may be added to the network node C of FIG. 7 having the address 29, the second child node may be added to the network node C of FIG. 7 having the address 33.

In FIG. 7, Cskip1(0) is 4, and Cskip2(0) is 4. The maximum number of addresses is 49.

In FIG. 2, the maximum number of addresses of the sensor network 10 is 122. Then, 25 network nodes are registered in the sensor network 10. That is, 97 addresses are wasted. In FIG. 7, the maximum number of addresses of the sensor network 30 is 49. Then, 25 network nodes are registered in the sensor network 30. That is, 24 addresses are wasted. Accordingly, the address usage efficiency of the sensor network 30 of FIG. 7 is higher than that of the sensor network 10 of FIG. 2.

The maximum number of addresses according to the max depth Lm of the sensor network 10 of FIG. 2 has been described in Table 3. The maximum number of addresses according to the max depth Lm of the sensor network 30 of FIG. 7 is described in Table 5 below.

TABLE 5

| Max Depth (Lm) | MaxAddress |
|---|---|
| 4 | 49 |
| 5 | 130 |
| 6 | 373 |
| . . . | . . . |
| 10 | 29533 |
| 11 | 88582 |
| 12 | 265729 |

That is, when the sensor network 30 of FIG. 7 uses a 16-bit address, the max depth Lm may be extended to 10. On the other hand, the max depth Lm of the sensor network 10 of FIG. 2 may be extended to 9. Accordingly, the scalability of the sensor network 30 of FIG. 7 is higher than that of the sensor network 10 of FIG. 2.

For example, when the network topology is configured, a plurality of reduced node depths TRm may be set. That is, a portion of network nodes may not be allowed to have inferior nodes in a plurality of routing depths of the network topology.

For example, when the network topology is configured, the topology of the sub cluster may be configured to be identical to that of the main cluster. That is, the main cluster may have a routing depth corresponding to the reduced node depth TRm, and the sub cluster may also have a routing depth corresponding to the reduced node depth TRm. In this case, the network topology may be generated based on the reduced node depth TRm, The max child Cm, and the max router Rm. Accordingly, the information for configuring the network topology may be simplified.

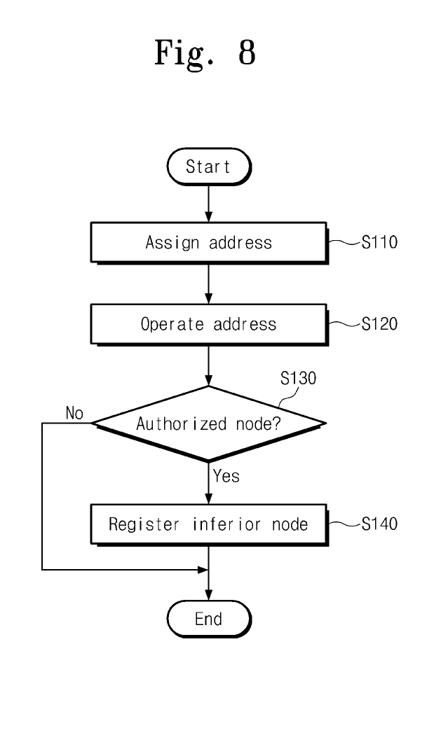

FIG. 8 is a flowchart illustrating an operation of a network node in the sensor networks 20 and 30 of FIGS. 5 and 7. For example, the operation for forming the sensor networks 20 and 30, or the operation of a network node for extending (or updating) the sensor networks 20 and 30 will be described. Among network nodes of the sensor networks 20 and 30, the operation of an inferior network node of a node having a reduced node depth TRm will be described. That is, the operation of a network node having a routing depth of ‘TRm+1’ will be described.

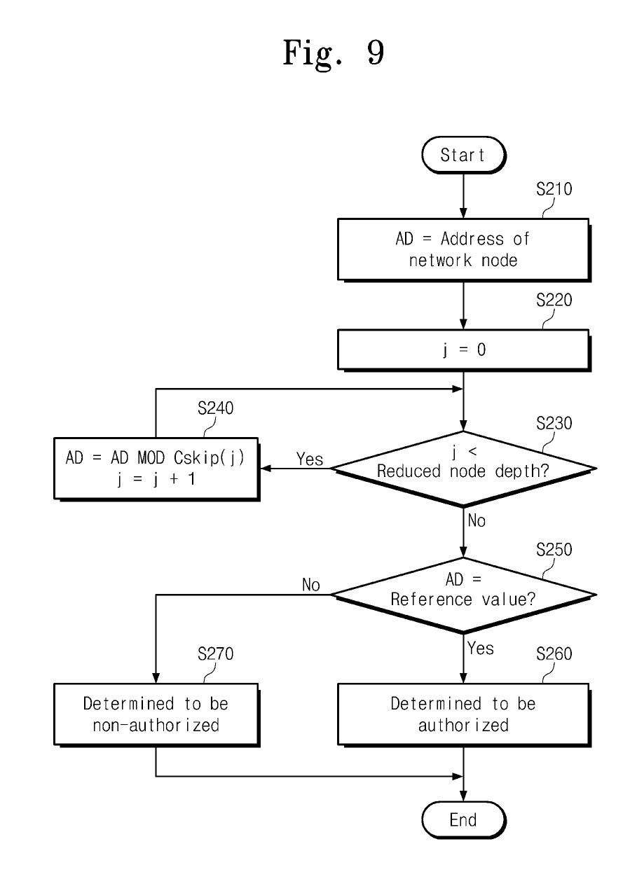

Referring to FIG. 8, in operation S110, addresses are assigned. Network nodes are assigned with addresses from superior nodes. In operation S120, address operations are performed. The network nodes may perform the address operation using the addresses assigned to them. Based on a result of the address operation, in operation S130, it is determined whether the network node is an authorized node. The address operation of operation S120 will be more fully described with reference to FIG. 9.

In operation S130, if the network node is not an authorized node, the procedure may end. That is, the network node does not generate an inferior node, and performs common communication or sensing. In operation S130, if the network node is an authorized node, operation S140 is performed. In operation S140, the network node may register a non-register node as an inferior node.

FIG. 9 is a flowchart illustrating the address operation of FIG. 8. The address operation is described with reference to FIGS. 4 and 9. For example, the network node of FIG. 4 having the address 29 is assumed to be the first node, and the network node having the address 25 is assumed to be the second node. The first node is an authorized node, and the second node is not an authorized node. It is assumed that the address operation is performed for the first and second nodes, respectively.

In operation S210, the value of a parameter AD may be set to an address of a network node. The parameter AD is set to 29 in the first node. The parameter AD is set to 25 in the second node.

In operation S220, the value of a parameter j is set to 0. In operation S230, it is determined whether the value of the parameter j is smaller than the reduced node depth TRm. In FIG. 4, the reduced node depth TRm is defined as 2. The value of the parameter j, 0 is smaller than the reduced node depth TRm, 2, operation S240 is performed.

In operation S240, the value of the parameter AD may be set to a remainder of its own value divided by Cskip1(j). Since the value of the parameter j is 0, Cskip1(0) may be used. Cskip1(0) represents the total number of the network nodes having a routing depth of 1 and the inferior nodes thereof in the main cluster. The value of Cskip1(0) is 13.

The inferior nodes of the network node having the address 1, the inferior nodes of the network node having the address 14, and the inferior nodes of the network node having the address 27 have the same structure. Also, the inferior nodes of the network node having the address 1, the inferior nodes of the network node having the address 14, and the inferior nodes of the network node having the address 27 have the same address range. Cskip1(0) number of addresses are assigned to the network node having the address 1 and the inferior nodes thereof. Cskip1(0) number of addresses are assigned to the network node having the address 14 and the inferior nodes thereof. Cskip1(0) number of addresses are assigned to the network node having the address 27 and the inferior nodes thereof. The addresses are sequential.

That is, the remainder of the address of the network node divided by Cskip1(0) represents a location corresponding to a network node when the network node is assumed to be an inferior node of the node having the address 1. The remainder of the address 29 of the node 1 divided by 13 is 3. That is, assuming that the first node having the address 29 is an inferior node of the node having the address 1, the location of the first node may correspond to the node having the address 3. The first node is the first child node of the first child node of the node having the address 27. The node having the address 3 is the first child node of the first child node of the node having the address 1. Accordingly, the first node may correspond to the node having the address 3.

The remainder of the address 25 of the node 2 is 12. That is, assuming that the second node having the address 25 is an inferior node of the node having the address 1, the location of the first node may correspond to the node having the address 12. The second node is the second child node of the third child node of the node having the address 14. The node having the address 12 is the second child node of the third child node of the node having the address 12. Accordingly, the second node may correspond to the node having the address 12.

Accordingly, the value of the parameter AD may be set to 3 in the first node. The value of the parameter AD may be set to 4 in the second node. Thereafter, the value of the parameter j may be added by 1.

In operation S230, it is determined whether the value of the parameter j is smaller than the reduced node depth TRm.

The value of the parameter j, 1 is smaller than the reduced node depth TRm 2. Accordingly, operation S240 may be performed.

In operation S240, the value of the parameter AD may be set a remainder of its own value divided by Cskip1(1). Cskil1(1) represents the total number of the network nodes having a routing depth of 2 and the inferior nodes thereof in the main cluster 100.

In case where the value of the parameter j is 0, the location of a network node has been calculated when the network node is assumed to be an inferior node of the node having the address 1. Similarly, in case where the value of the parameter j is 1, the location of a network node may be calculated when the network node is assumed to be an inferior node of the node having the address 2. That is, the value of the parameter AD represents the corresponding address of a network node when the network node is assumed to be connected to the node having the smallest address among the nodes having a routing depth of ‘j+1’.

The value of Cskip1(1) is 4. The value of the parameter AD calculated in the previous operation is 3 in the first node. The remainder of the value of the parameter AD, 3 divided by the value of Cskip1(1), 4 is 3. That is, the value of the parameter AD may be set to 3. The first node is the first nod of the node having the address 23. The node having the address 3 is the first node of the node having the address 2. That is, when the network node is assumed to be an inferior node of the node having the address 2, the second node may corresponds to the node having the address 3.

The value of the parameter AD calculated in the previous operation is 12 in the second node. The remainder of the value of the parameter AD, 12 divided by the value of Cskip1(1), 4 is 0. That is, the remainder can be understood as 4. The value of the parameter AD may be set to 4. The second node having the address 25 is the second node of the node having the address 23. The node having the address 4 is the second node of the node having the address 2. That is, when the second node is assumed to be an inferior node of the node having the address 2, the second node may corresponds to the node having the address 4.

Thereafter, the value of the parameter j may be added by 1. In operation S230, the value of the parameter j, 2 is not smaller than the reduced node depth TRm, 2. Accordingly, operation S250 may be performed.

In operation S250, it is determined whether the value of the parameter AD corresponds to the reference value. For example, the reference value may represent the address of an authorized node among the inferior nodes of the node having the address 2. If the number of the authorized nodes is plural, the number of the reference values may also be plural. If the value of the parameter AD is different from the reference value, the network node may be determined to be a non-authorized node in operation S270. If the value of the parameter AD corresponds to the reference value, the network node may be determined to be an authorized node in operation S260.

The address of the authorized node among the inferior nodes of the node having the address 2 is 3. Accordingly, the first node may be determined to be an authorized node, and the second node may be determined to be a non-authorized node.

In brief, in operations S230 and S240, it is assumed that the network node is connected to the node having the smallest address among the nodes, the routing depth of which corresponds to the reduced node depth TRm. The corresponding address AD of the network node may be calculated. In operation S250, the corresponding address AD may be compared to the reference value. That is, it is determined whether the network node is an authorized node, based on its address, reference value, and value of Cskip(j).

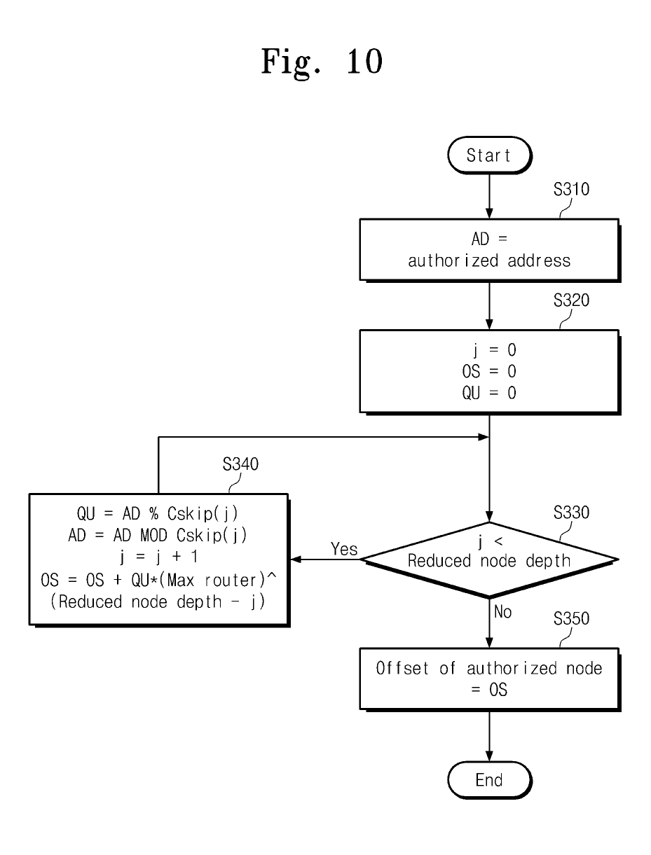

FIG. 10 is a flowchart illustrating a method for an authorized node to calculate addresses to be assigned to inferior node of a sub cluster. For example, it is assumed that the network node of FIG. 4 having the address 20 is the first node, and the network node having the address 29 is the second node. The first and second nodes are authorized nodes.

Referring to FIGS. 4 and 10, in operation S310, the value of the parameter AD may be set to the address of the authorized node. The value of the parameter AD may be set to 20 in the first node. The value of the parameter Ad may be set to 29 in the second node.

In operation S320, the value of the parameter j may be set to 0, the value of the parameter OS may be set to 0, and the value of the parameter QU may be set to 0.

In operation S330, it is determined whether the value of the parameter j is smaller than the reduced node depth TRm.

The value of the parameter j, 0 is smaller than the reduced node depth TRm, 2. Accordingly, operation S340 may be performed.

In operation S340, the operation ‘A % B’ represents an operation for calculating a quotient of A divided by B. That is, the value of the parameter QU may be set with the quotient of the value of the parameter AD divided by Cskip1(j).

Cskip1(0) represents the total number of the inferior nodes of the coordinator node and the inferior nodes thereof. Accordingly, if the quotient of the address AD of the network node divided by Cskip1(0) is 0, the network node may be determined to be an inferior node of the first child node of the coordinator node. If the quotient of the address AD of the network node divided by Cskip1(0) is 1, the network node may be determined to be an inferior node of the second child node of the coordinator node.

That is, the value of the parameter QU may share a node having a routing depth of j with the network node, and represent what node the network node is connected to among the network nodes having a routing depth of ‘j+1’.

The value of the parameter AD is 25 in the first node, and Cskip(0) is 13. Accordingly, the parameter QU may be set to 1. That is, the first node having the address 25 may be determined to be the second child node of the coordinator node, i.e., an inferior node of the node having the address 14.

The value of the parameter AD is 29 in the second node. Accordingly, the parameter QU may be set to 2. That is, the second node having the address 29 may be determined to be the third child node of the coordinator node, i.e., an inferior node of the node having the address 27.

Thereafter, the value of the parameter AD may be set to a remainder of its own value divided by Cskip(j).

The meaning of the value of the parameter AD has been described in detail with reference to FIG. 9. Accordingly, detailed description thereof will be omitted herein. The value of the parameter AD may be set to 7 in the first node. The value of the parameter AD may be set to 3 in the second node.

Next, the value of the parameter j may be added by 1.

Thereafter, the value of the parameter OS may be added by a product of the parameter QU and the max router Rm to the power of the reduced node depth TRm minus j.

In case of the first node, the value of the parameter QU is 1, the max router TRm is 3, and the reduced node depth TRm minus j is 1. Accordingly, the value of the parameter OS may be set to 3 in the first node.

In case of the second node, the value of the parameter QU is 2, the max router TRm is 3, and the reduced node depth TRm minus j is 1. Accordingly, the value of the parameter OS may be set to 3 in the second node.

The value of the parameter OS may share a node having a routing depth of ‘j+1’ with the network node among nodes having a routing depth of j, and represent the number of authorized nodes which a node having a smaller address than a node connected to the network node has.

It is assumed that one of inferior nodes of a node corresponding to the reduced node depth TRm is set to an authorized node. In this case, the number of authorized nodes which a node corresponding to the routing depth of 1 has may be defined as ‘max router (Rm)̂(reduced node depth (TRm)−1)’. The value of the parameter QU represents what node among nodes having a routing depth of 1 the network node is connected to. Accordingly, the product of the parameter QU and ‘max router Rm̂(reduced node depth (TRm)−1) represents the number of authorized nodes sharing a node having a routing depth of 0 with the network node and having a smaller address than a node connected to the network node, among the nodes having a routing depth of 1.

The first node may be connected to the second node (address 14) among the network nodes having a routing depth of 1. The first node (address 1) of the network nodes having a routing depth of 1 may have three authorized nodes.

The second node may be connected to the third node (address 27) among the network nodes having a routing depth of 1. The first node (address 1) and the second node (address 14) of the network nodes having a routing depth of 1 may have six authorized nodes.

In operation S330, it is determined whether the value of the parameter j is smaller than the reduced node depth TRm.

The value of the parameter j, 1 is smaller than the reduced node depth TRm. Accordingly, operation S340 may be performed.

In operation S340, the value of the parameter QU may be calculated. The value of the parameter AD calculated in the previous operation may be 7 in the first node. The value of the parameter AD calculated in the previous operation may be 3 in the second node. Cskip1(1) is 4. Accordingly, the value of the parameter QU may be set to 1 in the first node. The value of the parameter QU may be set to 0 in the second node.

As shown in FIG. 4, the first node may be connected to the second node (address 19) among the child nodes (address 15, 19 and 23) of the network node (address 14) having a routing depth of 1. The second node may be connected to the first node (address 28) among the child nodes (address 28, 32 and 36) of the network node (address 28) having a routing depth of 1.

Next, the value of the parameter AD may be calculated. The value of the parameter AD may be set to 3 in the first node. The value of the parameter AD may be set to 3 in the second node.

Thereafter, the value of the parameter j may be added by 1.

The value of the parameter OS may be calculated. The value of the parameter OS may be 3 in the first node. The value of the parameter QU may be 1, and the max router Rm may be 3. The reduced node depth TRm may be set to 2. Accordingly, the value of the parameter OS may be set to 4.

The value of the parameter OS may be 6 in the second node. The value of the parameter QU may be 0, and the max router Rm may be 3. The reduced node depth TRm may be set to 2. Accordingly, the value of the parameter OS may be set to 6.

In operation S330, the value of the parameter, 2 is not smaller than the reduced node depth TRm. Accordingly, operation S350 may be performed. In operation S350, the parameter OS may be defined as an offset of an authorized node. The value of the parameter OS may represent the number of nodes having a smaller address than the network node among authorized nodes of the main cluster 100. The value of the parameter OS may be 4 in the first node. As shown in FIG. 4, the number of authorized nodes having a smaller address than the first node having the address 20 is four (address 1, 7, 11 and 16). The value of the parameter OS may be 6 in the second node. As shown in FIG. 4, the number of authorized node having a smaller address than the second node having the address 29 is 6 (address 1, 7, 11, 16, 20 and 24).

As described above, the network node may calculate an offset based on its own address, the max router Rm, the reduced node depth TRm, and Cskip1(j).

If the offset is calculated, the addresses assigned to the inferior nodes of the sub cluster can be calculated. The addresses to be assigned to the inferior nodes in the sub cluster may be expressed as Equation (5) below.

Address=MaxAddress of Main Cluster+OS*(MaxAddress of Sub Cluster−1) (5)

The authorized node may be a node of the sub cluster 200, and may also be a node of the main cluster 100. That is, one node is duplicated in the sub cluster 200 and the main cluster 100. Accordingly, the offset OS is multiplied by the maximum number of addresses of the sub cluster minus 1.

In the first node having the address 20, the offset OS may be 4, and the maximum number of addresses of the main cluster 100 may be 40. The maximum number of addresses of the sub cluster 200 may be 4. Accordingly, the addresses that the first node assigns to the inferior nodes in the sub cluster may start from 52.

In the second node having the address 29, the offset OS may be 6, and the maximum number of addresses of the main cluster 100 may be 40. The maximum number of addresses of the sub cluster 200 may be 4. Accordingly, the addresses that the second node assigns to the inferior nodes in the sub cluster may start from 58.

For example, it is assumed that n nodes among the inferior nodes of the network node of the reduced node depth TRm are set to authorized nodes. In this case, the addresses to be assigned to the inferior nodes in the sub cluster may be expressed as Equation (6) below.

Address=MaxAddressof Main Cluster+2*OS*(MaxAddressof Sub Cluster−1) (6)

Except that the address part of the sub cluster becomes double, Equation (6) is identical to Equation (5).

As described above, in the sensor networks 20 and 30 according to the embodiments, a portion of inferior nodes of a network node corresponding to the reduced node depth TRm may not be allowed to have an inferior node. Accordingly, the number of wasted addresses can be minimized, and network scalability can be improved.

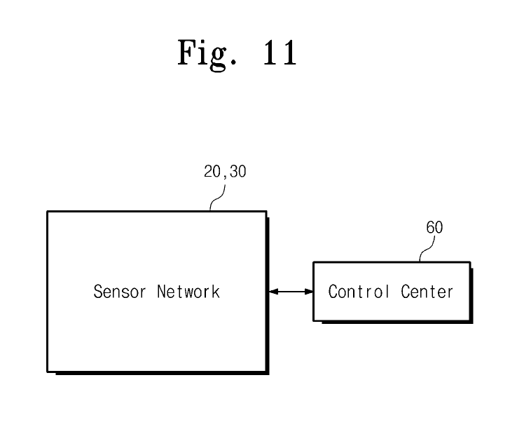

FIG. 11 is a diagram illustrating a sensor system including the sensor network 20 or 30 of FIG. 5 or 7 according to a first embodiment. Referring to FIG. 11, a sensor system may include a sensor network 20 or 30 and a control center 70. The sensor network 20 or 30, as described with reference to FIGS. 4 through 10, may generate a sub cluster dynamically when a non-registered node is detected.

The control center 70 may collect a sensing result from the sensor network 20 or 30. For example, based on the sensing result collected from the sensor network 20 or 30, the control center 70 may monitor a region corresponding to the sensor network 20 or 30 in real-time. Based on the sensing result collected from the sensor network 20 or 30, the control center 70 may monitor whether events such as criminals, disasters, accidents, and border disputes occur in the region corresponding to the sensor network 20 or 30. For example, based on the sensing result collected from the sensor network 20 or 30, the control center 70 may acquire information on weather, parking, and illumination controlling situations in the region corresponding to the sensor network 20 or 30.

For example, two or more sensor networks may be connected to the control center 70. The control center 70 may monitor the region corresponding to two or more sensor networks in real-time.

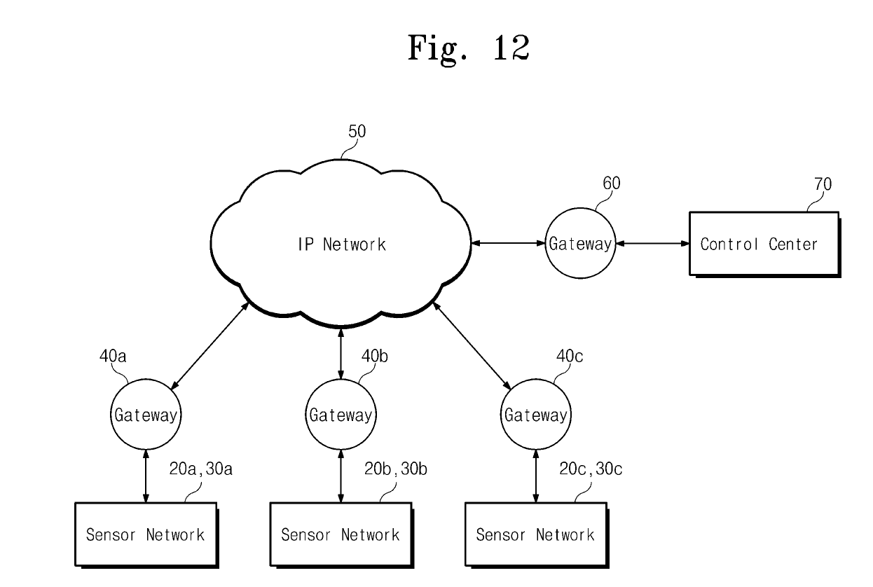

FIG. 12 is a diagram illustrating a sensor system including the sensor network 20 or 30 of FIG. 5 or 6 according to a second embodiment. Referring to FIG. 12, a sensor system may include a plurality of sensor networks 20a to 20c or 30a to 30c, a plurality of gateways 40a to 40c and 60, an Internet Protocol (IP) network 50, and a control center 70.

The respective sensor networks 20a to 20c or 30a to 30c, as described with reference to FIGS. 4 through 10, may generate a sub cluster dynamically when a non-registered node is detected. The sensor networks 20a to 20c or 30a to 30c may be connected to corresponding gateways 40a to 40c, respectively. The sensor networks 20a to 20c or 30a to 30c may be connected to the IP network 50 through the gateways 40a to 40c. The control center 70 may also be connected to the IP network 50 through the gateway 60.

The control center 70 may collect a sensing result from the sensor networks 20a to 20c or 30a to 30c. For example, the sensing result of the sensor networks 20a to 20c or 30a to 30c may be delivered to the IP network 50 through corresponding gateways 40a to 40c. In the IP network 50, the sensing result may be delivered to the gateway 50 connected to the control center 70. The control center 70 may receive the sensing result of the sensor networks 20a to 20c or 30a to 30c from the gateway 60.

Based on the sensing result collected from the sensor networks 20a to 20c or 30a to 30c, the control center 70 may monitor a region corresponding to the sensor networks 20a to 20c or 30a to 30c in real-time. For example, based on the sensing result collected from the sensor networks 20a to 20c or 30a to 30c, the control center 70 may monitor whether events such as criminals, disasters, accidents, and border disputes occur in the regions corresponding to the sensor networks 20a to 20c or 30a to 30c. For example, based on the sensing result collected from the sensor networks 20a to 20c or 30a to 30c, the control center 70 may acquire information on weather, parking, and illumination controlling situations in the regions corresponding to the sensor networks 30a to 30c.

Through the sensor networks 20a to 20c or 30a to 30 connected to the IP network 50, the control center 70 may perform wide area monitoring based on a plurality of sensor networks 30a to 30c. For example, the control center 70 may perform a real-time monitoring for regions corresponding to town, township, street, district, county, city, province, or country.

For example, the sensor networks 20a to 20c or 30a to 30c may be connected to the IP network 50 via a satellite. If the sensor networks 30a to 30c are connected to the IP network 50 through a satellite, remote area monitoring can also be performed for islands, mountain areas, oversea branches, and oversea public offices.

According to the embodiments, only a portion of network nodes corresponding to a reduced node depth has a child node. Accordingly, network scalability can be extended, and address waste of a network can reduced.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for operating a network node of a tree-structured network based on distributed address assignment, the method comprising:
assigning addresses;
determining whether a routing depth of the network node corresponds to a reduced node depth;
determining whether an authority for generating an inferior node exists using the assigned address when the routing depth of the network node corresponds to the reduced node depth; and
generating the inferior node using a result of the determination.

2. The method of claim 1, wherein the generating of the inferior node comprises generating the inferior node when the determination result shows the existence of the authority.

3. The method of claim 1, wherein the generating of the inferior node comprises inhibiting generation of the inferior node when the determination result shows absence of the authority.

4. The method of claim 1, wherein the reduced node depth is smaller than the routing depth of the network.

5. A method for forming a tree-structured network based on distributed address assignment, the method comprising:
setting a reduced node depth; and
forming a network using the reduced node depth,
wherein a portion of inferior nodes of a node having a routing depth corresponding to the reduced node depth is not allowed to have an inferior node.

6. The method of claim 5, wherein the portion of the inferior nodes comprises routing nodes.

7. The method of claim 5, wherein the reduced node depth is smaller than the routing depth of the network.

8. The method of claim 5, wherein respective network nodes of the network determine whether to have an inferior node based on an assigned address.

9. A system comprising:
a coordinator node; and
a plurality of sensor nodes connected to the coordinator node in a tree structure,
wherein the coordinator and the plurality of sensor nodes are assigned with addresses based on distributed address assignment, and a portion of the sensor nodes having a routing depth corresponding to a reduced node depth is not allowed to have an inferior node.

10. The system of claim 9, wherein the portion of the sensor nodes comprises routing nodes.
